(19) United States
(12) Patent Application Publication
(10) Pub. No.: US 2007/0137380 A1
(43) Pub. Date: Jun. 21, 2007

(54) Steering column assembly

(75) Inventor: Steven A. Peppler, Mulberry, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/292,987

(22) Filed: Dec. 2, 2005

(51) Int. Cl. B62D 1/18

(52) U.S. Cl. 74/493

(57) ABSTRACT

An adjustable steering column assembly includes a force sensor which is operable to provide an output signal in response to manual application of force to a steering wheel. An actuator is connected with a steering column assembly and is operable to adjust the steering column assembly to change the steering wheel position in response to the output signal from the force sensor.

### BACKGROUND OF THE INVENTION

The present invention relates to a steering column assembly and more specifically to a steering column assembly which is adjustable.

A known steering column assembly has tilt and telescope adjustment features. This known steering column assembly is provided with a motor which is operated in response to actuation of a switch by a driver of a vehicle. Operation of the motor varies the telescopic relationship between inner and outer steering column members.

Similarly, a second switch is associated with the known steering column assembly and is actuatable by the driver of the vehicle to operate a second motor. Operation of the second motor varies the tilt of an upper portion of the steering column assembly and a steering wheel relative to the remainder of the steering column assembly. A steering column assembly having this general construction is disclosed in U.S. Pat. No. 5,520,416.

### SUMMARY OF THE INVENTION

An improved apparatus for use in steering a vehicle includes an adjustable steering column assembly. A force sensor connected with the steering column assembly is operable to provide an output signal in response to manual application of force to a steering wheel connected with the steering column assembly. An actuator is connected with the steering column assembly and is operable to adjust the steering column assembly to change steering wheel position in response to the output signal from the force sensor. This enables the position of the steering wheel to be adjusted in response to manual application of force to the steering wheel.

Although the steering column assembly may be constructed so as to provide for only tilt adjustment or for only telescope adjustment, in one embodiment of the invention, the steering column assembly is constructed so as to provide tilt and/or telescope adjustment in response to manual application of force to the steering wheel. In this particular embodiment of the invention, a first sensor is connected with the steering column assembly to provide an output signal in response to manual application of force to the steering wheel in a direction along a longitudinal central axis of the steering column assembly. A first actuator is operable in response to the output signal from the first sensor to vary the telescopic relationship between first and second steering column members and the position of the steering wheel along the longitudinal central axis of the steering column assembly.

In the aforementioned embodiment of the invention in which a steering column assembly has tilt and telescope adjustment features, a second sensor is connected with the steering column assembly to provide an output signal in response to manual application of force to the steering wheel in a direction transverse to the longitudinal central axis of the steering column assembly. A second actuator is connected to the steering column assembly and is operable in response to the output signal from the second sensor to pivot a portion of the steering column assembly about an axis extending transverse to the longitudinal central axis of the steering column assembly. Operation of the second actuator is effective to vary the angular orientation of the steering wheel relative to the longitudinal central axis of the steering column assembly.

### BRIEF DESCRIPTION OF THE DRAWINGS

The foregoing and other features of the present invention will become apparent to one skilled in the art upon reading the following description of the present invention with reference to the accompanying drawings, wherein:

FIG. 1 is a schematic illustration of an apparatus for use in steering a vehicle;

FIG. 2 is a schematic illustration of an adjustable steering column assembly utilized in the apparatus of FIG. 1;

FIG. 3 is a schematic pictorial illustration of one embodiment of the steering column assembly of FIG. 2; and

FIG. 4 is a schematic side elevational view, taken generally along the line 4-4 of FIG. 3, further illustrating the construction of the steering column assembly.

### DESCRIPTION OF PREFERRED EMBODIMENTS OF THE INVENTION

An apparatus 10 for use in turning steerable vehicle wheels 12 and 14 is illustrated in FIG. 1. The apparatus 10 includes a steering wheel 16 which is connected with an adjustable steering column assembly 18 (FIGS. 1-4). A steering gear 20 (FIG. 1) connects the steering column assembly 18 with the steerable vehicle wheels 12 and 14. The steering gear 20 is of the well-known power rack and pinion gear type. However, it is contemplated that a different type of steering gear may be utilized if desired. For example, the steering gear 20 may be a manual steering gear rather than a power steering gear. As another example, the steering gear 20 may be of the integral type.

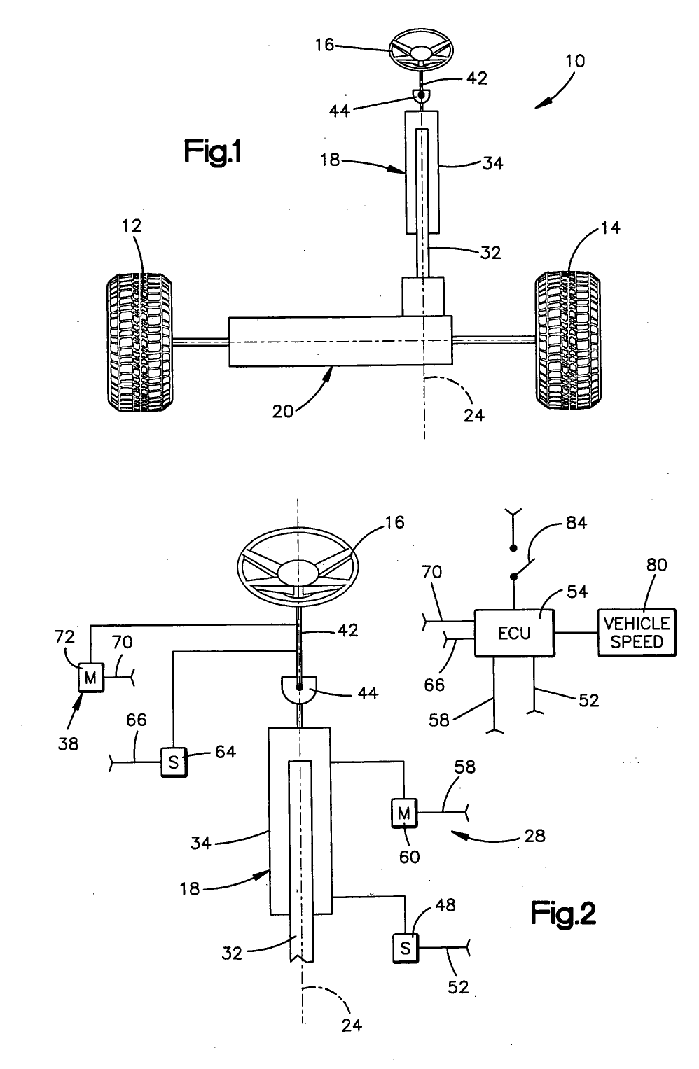

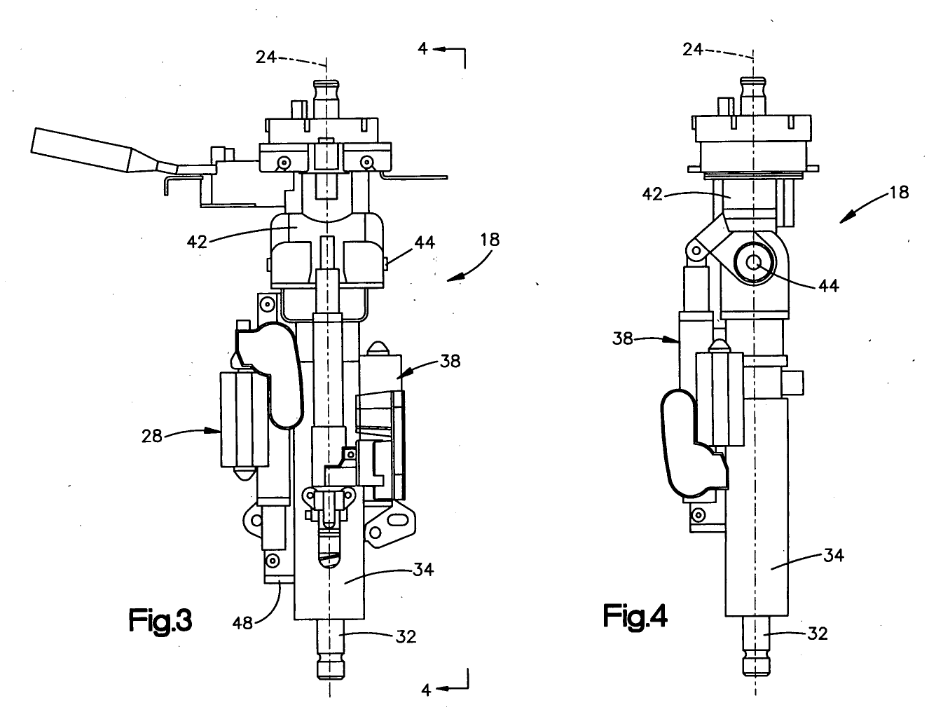

In accordance with one of the features of the present invention, the steering column assembly 18 is adjusted in response to manual application of force to the steering wheel 16. When force is manually applied to the steering wheel 16 in a direction along a longitudinal central axis 24 of the steering assembly 18, a first or telescope actuator 28 (FIGS. 2 and 3) is operated to vary the telescopic relationship between inner and outer members 32 and 34 of the adjustable steering column assembly 18. When the telescopic relationship between the inner and outer members 32 and 34 is to be varied, the outer member 34 is moved relative to the inner member 32. However, the steering column assembly 18 may be constructed so that the inner member 32 is moved relative to the outer member 34 when their telescopic relationship is to be varied. A change in the telescopic relationship between the inner and outer members 32 and 34 moves the steering wheel 16 either toward or away from a driver of the vehicle.

When force is manually applied to the steering wheel 16 in a direction transverse to the longitudinal central axis 24 of the steering column assembly 18, a second or tilt actuator 38 (FIGS. 2, 3 and 4) is operated to pivot an upper steering column member 42 about a pivot joint 44. When the upper steering column member 42 is pivoted, the angular orientation of the steering wheel 16 relative to the longitudinal central axis of the steering column assembly 18 is varied. This effects a change in the angular orientation or tilt of the steering wheel 16 relative to a driver of the vehicle.

The actuators 28 and 38 may be simultaneously operated to simultaneously effect both tilt and telescopic adjustment of the steering wheel 16. Alternatively, the actuators 28 and 38 may be sequentially operated to sequentially effect tilt and telescopic adjustment of the steering wheel 16. Of course only telescopic or tilt adjustment of the steering wheel 16 may be obtained operating only one of the actuators 28 and 38.

In the embodiment of the invention illustrated in FIGS. 1-4, force is manually applied to the steering wheel 16 to vary: (1) the position of the steering wheel along the longitudinal central axis 24 of the steering column assembly 18 and/or (2) the angular orientation of the steering wheel relative to the longitudinal central axis of the steering column assembly. However, it is contemplated that the steering column assembly 18 may be constructed with only one of the actuators 28 and 38. For example, if only the angular relationship of the steering wheel 16 is to be adjusted, only the tilt actuator 38 would be provided. Similarly, if only the position of the steering wheel along the longitudinal central axis 24 of the steering column is to be adjusted, only the telescope actuator 28 would be provided.

When the actuators 28 and 38 are not being operated, they are effective to prevent either tilt or telescopic adjustment of the steering wheel 16. When the telescope actuator 28 is not being operated, the inner and outer members 32 and 34 are held against telescopic movement relative to each other. Similarly, when the tilt actuator 38 is not being operated, the upper steering column member 42 is held against pivotal movement at the pivot joint 44.

When a driver of a vehicle wishes to change the position of the steering wheel 16 along the longitudinal central axis 24 of the steering column assembly 18, the driver manually applies force to the steering wheel 16 (FIG. 2) to either push or pull the steering wheel. The manual application of force to the steering wheel 16 in a direction which extends along the longitudinal central axis 24 of the steering column 18 is detected by a force sensor 48 (FIGS. 2 and 3) which is connected to the outer member 34 of the steering column 18. The force sensor 48 is a load cell which provides an output signal along a lead 52 (FIG. 2) to an electronic control unit 54.

In response to the signal from the force sensor 48, the electronic control unit 54 (FIG. 2) provides an output signal over a lead 58 to energize a reversible electric motor 60 in the telescope actuator 28. The motor 60 is then operated to effect movement of the outer member 34 along the longitudinal central axis 24 of the steering column 18. Operation of the motor 60 effects movement of the steering wheel 16 in a direction either toward the operator of the vehicle or away from the operator of the vehicle depending upon the direction of the force which is manually applied to the steering wheel 16 by the operator of the vehicle.

If the operator manually applies the force to the steering wheel 16 pulling the steering wheel upward or toward himself, the motor 60 is operated in one direction to move the outer member 34 and steering wheel 16 upward (as viewed in FIGS. 1-4) toward the operator. Similarly, if the operator manually applies force to the steering wheel 16 pushing the steering wheel away from himself, the motor 60 is operated in the opposite direction to move the outer member 34 and steering wheel downward along the longitudinal central axis 24 of the steering column assembly 18.

The motor 60 in the telescope actuator 28 is a reversible electric motor. However, if desired, a reversible hydraulic or pneumatic motor may be utilized.

A force sensor 64 (FIG. 2) is provided to detect the manual application of force to the steering wheel in a direction transverse to the longitudinal central axis 24 of the steering column. The sensor 64 is connected with the upper steering column member 42 (FIGS. 2, 3 and 4). Upon manual application of force to the steering wheel 16 (FIG. 2) in a direction transverse to the central axis 24 of the steering column, the sensor 64 provides an output over a lead 66 to the electronic control unit 54.

In response to a signal over the lead 66, the electronic control unit 54 (FIG. 2) transmits a signal over a lead 70 to energize a reversible electric motor 72 in the actuator 38. Upon operation of the motor 72, the upper steering column member 42 and steering wheel 16 are pivoted together about the connection 44 to change the angular orientation of the steering wheel 16 relative to the longitudinal central axis 24 of the steering column 18. Depending upon whether the force applied to the steering wheel 16 is in a direction toward or away from the operator, the reversible electric motor 72 is operated to either tilt the steering wheel 16 toward the operator or to tilt the steering wheel away from the operator.

The motor 72 in the tilt actuator is a reversible electric motor. However, if desired, a reversible hydraulic or pneumatic motor may be utilized.

The sensors 48 and 64 are load cells which measure force transmitted from the steering wheel 16 to a component of the steering column assembly 18. Thus, the force sensor 48 is a load cell which measures force transmitted from the steering wheel 16 to the outer member 34 of the steering column assembly in a direction along the longitudinal central axis 24 of the steering column assembly. Similarly, the force sensor 64 measures force transmitted from the steering wheel to the upper steering column member 42 in a direction transverse to the central axis 24 of the steering column assembly.

The load cells of the force sensors 48 and 64 contain strain gauges having an output which varies as a function of the magnitude of the force which is manually applied to the steering wheel 16. Alternatively, the force sensors 48 and 64 may include load cells containing piezoelectric devices having output signals which vary as a function of the magnitude of the force which is manually applied to the steering wheel 16. Of course, other known force sensors may be utilized.

It is contemplated that tilt and/or telescope adjustments will be applied to the steering column assembly 18 when the vehicle in which the steering column assembly is disposed has stopped. Therefore, a vehicle speed sensor 80 is connected with the electronic control unit 54. The electronic control unit 54 effects operation of one or both of the reversible electric motors 60 and 72 to adjust the position of the steering wheel 16 relative to the occupant of the vehicle only when the vehicle is stopped. If desired, a sensor which detects when a transmission of the vehicle is in park may be substituted for the speed sensor.

In order to prevent inadvertent changing of the orientation of the steering wheel 16 by an operator of a vehicle, a control switch 84 is connected with the electronic control unit 54. The control switch 84 must be actuated before the electronic control unit 54 effects operation of either the motor 60 in the telescope actuator 28 or the motor 72 in the tilt actuator 38 when the vehicle is stopped. If desired, the manually actuated control switch 84 may be omitted.

When the vehicle is being driven along the road by an operator of the vehicle, the operator may rotate the steering wheel 16 about the longitudinal central axis 24 of the steering column assembly 18 to effect turning movement of the steerable vehicle wheels 12 and 14 in a known manner. During rotation of the steering wheel to turn the steerable vehicle wheels 12 and 14, the electronic control unit 54 does not energize the electric motors 60 and 72. Therefore, telescopic and/or tilt adjustments can not be made to the steering column assembly 18 during steering of the vehicle.

When the vehicle has been stopped and the control switch 84 has been actuated, the driver of the vehicle may push or pull on the steering wheel 16 to effect a telescopic adjustment in the steering column assembly 18, or a tilt adjustment in the steering column assembly or a combination of a tilt and telescopic adjustment in the steering column assembly. Thus, the motor 60 may be energized to effect only a change in the telescopic relationship between the inner and outer members 32 and 34 of the steering column 18. Alternatively, only the motor 72 may be energized to effect pivotal movement of the upper steering column member 42 about an axis extending perpendicular to the central axis 24 of the steering column at the pivot joint 44. Alternatively, if a combination of forces are manually applied to the steering wheel 16 by the operator of the vehicle, the motor 60 may be energized to change the position of the steering wheel 16 along the axis 24 while the motor 72 is energized to change the angular orientation of the steering wheel relative to the axis 24.

It is contemplated that the inner and outer steering column members 32 and 34 and the upper steering column member 42 may be interconnected in the same manner as is disclosed in U.S. Pat. No. 5,711,189. It is also contemplated that the motor 60 may be connected with the outer member 34 of the steering column assembly 18 and that the motor 72 may be connected with the upper steering column member 42 by flexible cables, in the same manner as is disclosed in U.S. Pat. No. 5,520,416. Of course, the steering column members 32, 34 and 42 may be interconnected in a manner which is different than disclosed in U.S. Pat. No. 5,711,189. Also, the motors 60 and 72 may be connected with the steering column members in a manner which is different than is disclosed in U.S. Pat. No. 5,520,416. For example, rack and pinion gearing may be utilized to transmit force from the motors 60 and 72 to the steering column members 34 and 42.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for use in steering a vehicle, said apparatus comprising:
a force sensor connected with an adjustable steering column assembly, said force sensor being operable to provide an output signal in response to manual application of force to a steering wheel connected with said steering column assembly; and
an actuator which is connected with said steering column assembly and is operable to adjust said steering column assembly to change steering wheel position in response to the output signal from said force sensor to thereby enable the position of the steering wheel to be adjusted in response to manual application of force to the steering wheel.

2. An apparatus as set forth in claim 1 wherein said force sensor is operable to sense a force component which is manually applied to the steering wheel in a direction along a central axis of said steering column assembly, said actuator being operable to move the steering wheel along the central axis of the steering column assembly in response to the output signal from said force sensor.

3. An apparatus as set forth in claim 1 wherein said force sensor is operable to sense a force component which is manually applied to the steering wheel in a direction transverse to a central axis of said steering column assembly, said actuator being operable to move the steering wheel transverse to the central axis of the steering column assembly in response to the output from said force sensor.

4. A tilt-telescope steering column assembly for supporting a steering wheel which is rotatable to turn steerable vehicle wheels, said steering column assembly comprising:
first and second steering column members which are disposed in a telescopic relationship and a third steering column member which is connected with the steering wheel and is pivotal relative to said first and second steering column members about an axis extending transverse to a longitudinal central axis of said steering column assembly,
a first sensor connected with said steering column assembly to provide an output signal in response to manual application of force to the steering wheel in a direction along the longitudinal central axis of said steering column assembly,
a first actuator connected to said steering column assembly and operable in response to the output signal from said first sensor to move said first steering column member relative to said second steering column member to vary the telescopic relationship between said first and second steering column members and position of the steering wheel along the longitudinal central axis of said steering column assembly,
a second sensor connected with said steering column assembly to provide an output signal in response to manual application of force to the steering wheel in a direction transverse to the longitudinal central axis of said steering column assembly, and
a second actuator connected to said steering column assembly and operable in response to the output signal from said second sensor to pivot said third steering column member about the axis extending transverse to the longitudinal central axis of said steering column assembly and vary the angular orientation of the steering wheel to the longitudinal central axis of the steering column assembly.
